(19) United States
(12) Patent Application Publication
(10) Pub. No.: US 2023/0191835 A1
(43) Pub. Date: Jun. 22, 2023

(54) NON-PNEUMATIC TIRE WITH IMPROVED SHEAR BAND

(71) Applicant: The Goodyear Tire & Rubber Company, Akron, OH (US)

(72) Inventor: Francesco Sportelli, Bettembourg (LU)

(21) Appl. No.: 18/045,225

(22) Filed: Oct. 10, 2022

Related U.S. Application Data
(60) Provisional application No. 63/265,615, filed on Dec. 17, 2021.

(51) Int. Cl. B60C 7/10; B60C 7/14

(52) U.S. Cl. CPC B60C 7/105; B60C 7/146

(57) ABSTRACT

A shear band and a non-pneumatic tire is described which includes a ground contacting annular tread portion; a shear band, and a connecting web positioned between a hub and the shear band. The shear band is preferably comprised of a three-dimensional spacer fabric having a first and second layer connected by connecting members. The three-dimensional spacer fabric has a defined depth. The three-dimensional spacer structure further includes a plurality of cells formed between the connecting members, and wherein one or more of the cells are filled with a filler material. The filler material may be foam or a thermoplastic elastomer.

### FIELD OF THE INVENTION

The present invention relates generally to vehicle tires and non-pneumatic tires, and more particularly, to an improved shear band for a non-pneumatic tire.

### BACKGROUND OF THE INVENTION

The pneumatic tire has been the solution of choice for vehicular mobility for over a century. The pneumatic tire is a tensile structure. The pneumatic tire has at least four characteristics that make the pneumatic tire so dominant today. Pneumatic tires are efficient at carrying loads, because all of the tire structure is involved in carrying the load. Pneumatic tires are also desirable because they have low contact pressure, resulting in lower wear on roads due to the distribution of the load of the vehicle. Pneumatic tires also have low stiffness, which ensures a comfortable ride in a vehicle. The primary drawback to a pneumatic tire is that it requires compressed gasses. A conventional pneumatic tire is rendered useless after a complete loss of inflation pressure.

A tire designed to operate without inflation pressure may eliminate many of the problems and compromises associated with a pneumatic tire. Neither pressure maintenance nor pressure monitoring is required. Structurally supported tires such as solid tires or other elastomeric structures to date have not provided the levels of performance required from a conventional pneumatic tire. A structurally supported tire solution that delivers pneumatic tire-like performance would be a desirous improvement.

Non pneumatic tires are typically defined by their load carrying efficiency. “Bottom loaders” are essentially rigid structures that carry a majority of the load in the portion of the structure below the hub. “Top loaders” are designed so that all of the structure is involved in carrying the load. Top loaders thus have a higher load carrying efficiency than bottom loaders, allowing a design that has less mass.

The purpose of the shear band is to transfer the load from contact with the ground through tension in the spokes or connecting web to the hub, creating a top loading structure. When the shear band deforms, its preferred form of deformation is shear over bending. The shear mode of deformation occurs because of the inextensible membranes located on the outer portions of the shear band. Prior art non-pneumatic tire typically have a shear band made from rubber materials sandwiched between at least two layers of inextensible belts or membranes. The disadvantage to this type of construction is that the use of rubber significantly increases the cost and weight of the non-pneumatic tire. Another disadvantage to the use of rubber is that is generates heat, particularly in the shear band. Furthermore, the rubber in the shear band needs to be soft in shear, which makes it difficult to find the desired compound.

Thus, an improved non-pneumatic tire is desired that has all the features of the pneumatic tires without the drawback of the need for air inflation is desired.

### BRIEF DESCRIPTION OF THE DRAWINGS

The present invention will be better understood through reference to the following description and the appended drawings, in which:

FIG. 1 is a perspective view of a first embodiment of a non-pneumatic tire of the present invention;

FIG. 2 is a cross-sectional view of a first embodiment of a shear band and outer tread; and

FIG. 3A is a top view of the three-dimensional fabric structure of FIG. 2;

FIG. 3B is a cross-sectional view of the three-dimensional fabric structure of FIG. 2: and

FIG. 3C illustrates various possible configurations of the cross-members.

### Definitions

The following terms are defined as follows for this description.

“Auxetic material” means a material that has a negative Poisson's ratio.

“Cord” means the twisted fiber or filament of polyester, rayon, nylon or steel which form a reinforcement cord.

“Equatorial Plane” means a plane perpendicular to the axis of rotation of the tire passing through the centerline of the tire.

“Fabric” means a network of cords which extend in in multiple directions.

“Free area” is a measure of the openness of the fabric per DIN EN 14971, and is the amount of area in the fabric plane that is not covered by yarn. It is a visual measurement of the tightness of the fabric and is determined by taking an electronic image of the light from a light table passing through a six inch by six inch square sample of the fabric and comparing the intensity of the measured light to the intensity of the white pixels.

“Inextensible” means that a given layer has an extensional stiffness greater than about 25 Ksi.

“Knitted” is meant to include a structure producible by interlocking a series of loops of one or more yarns by means of needles or wires, such as warp knits and weft knits.

“Three-dimensional spacer structure” means a three-dimensional structure composed from two outer layers of fabric, each outer layer of fabric having reinforcement members (such as yarns, filaments or fibers) which extend in a first and second direction, wherein the two outer layers are connected together by reinforcement members (yarns, filaments or fibers) or other knitted layers that extend in a defined third direction. An “open” three-dimensional spacer structure is comprised of individual pile fibers or reinforcements that connect the first and second layer of fabric. A “closed” three-dimensional structure utilizes fabric piles that connect the first and second layers.

“Yarn” means a continuous strand of textile fibers or filaments. A monofilament yarn has only a single filament with or without twist.

“Woven” is meant to include a structure produced by multiple yarns crossing each other at right angles to form the grain, like a basket.

### DETAILED DESCRIPTION OF THE INVENTION

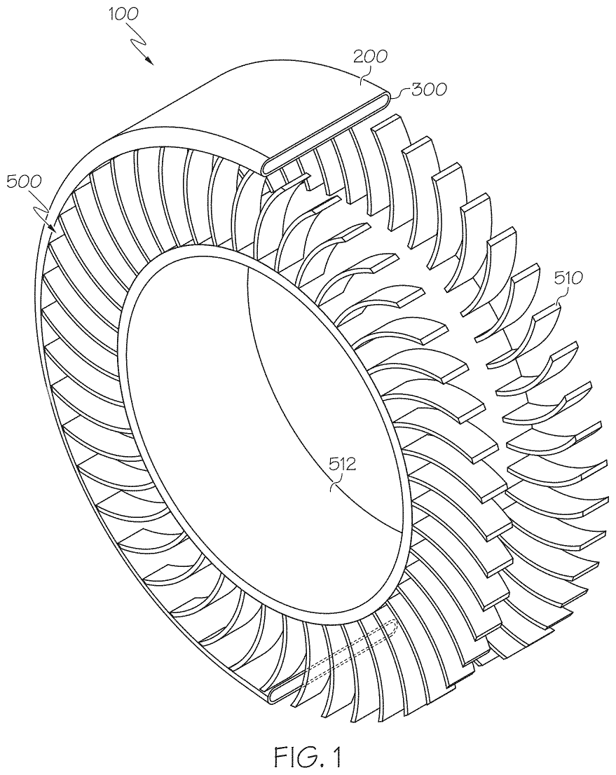

A first embodiment of a non-pneumatic tire 100 of the present invention is shown in FIG. 1. The tire of the present invention includes a radially outer ground engaging tread 200, a shear band 300, and a connecting web 500. The tire tread 200 may include elements such as ribs, blocks, lugs, grooves, and sipes as desired to improve the performance of the tire in various conditions. The connecting web 500 is mounted on a hub 512 and may have different designs, such as spokes or a elastomeric web. The non-pneumatic tire of the present invention is designed to be a top loading structure, so that the shear band 300 and the connecting web 500 efficiently carry the load. The shear band 300 and the connecting web are designed so that the stiffness of the shear band is directly related to the spring rate of the tire. The connecting web is designed to be a stiff structure when in tension that buckles or deforms in the tire footprint and does not compress or carry a compressive load. This allows the rest of the connecting web not in the footprint area the ability to carry the load, resulting in a very load efficient structure. It is desired to allow the shearband to bend to overcome road obstacles. The approximate load distribution is preferably such that approximately 90-100% of the load is carried by the shear band and the upper portion of the connecting web, so that the lower portion of the connecting web carry virtually zero of the load, and preferably less than 10%.

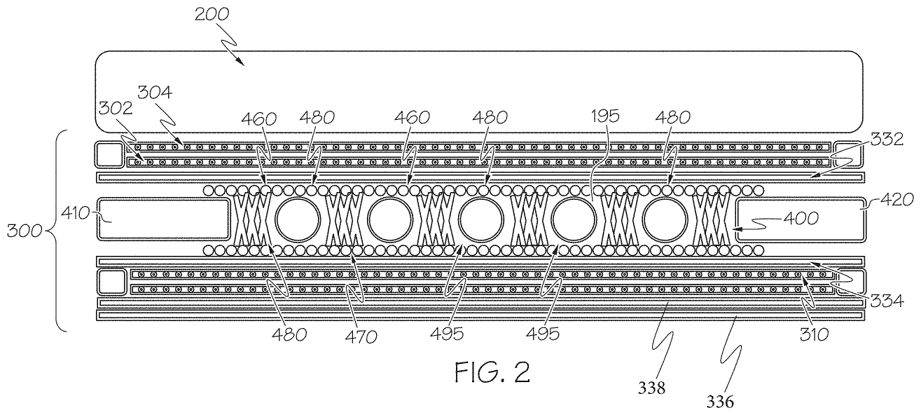

The shear band 300 is preferably an annular structure that is located radially inward of the tire tread 200. The shear band includes a three-dimensional spacer structure 400, shown in FIG. 2. The three-dimensional spacer structure 400 may be positioned between a first and second layer of gum rubber 332,334 (not shown to scale). The gum rubber 332,334 may be as thick as desired.

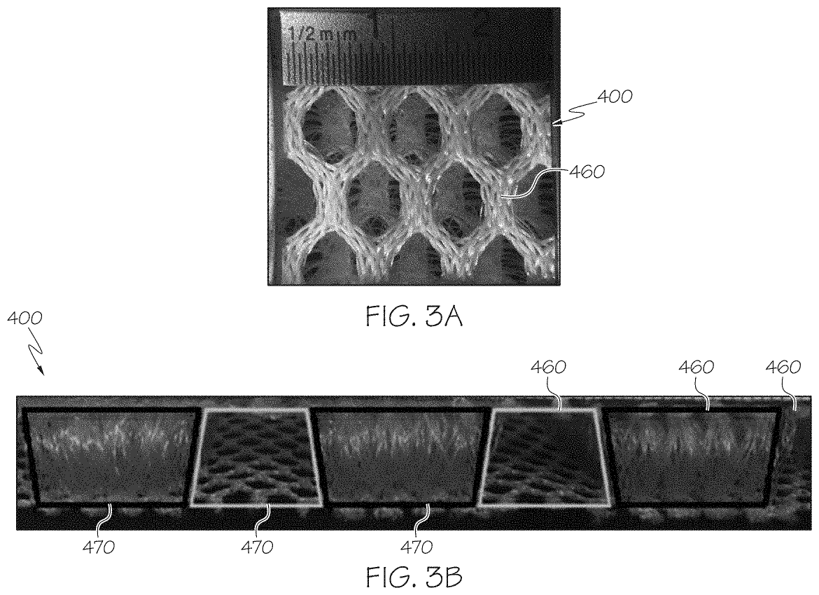

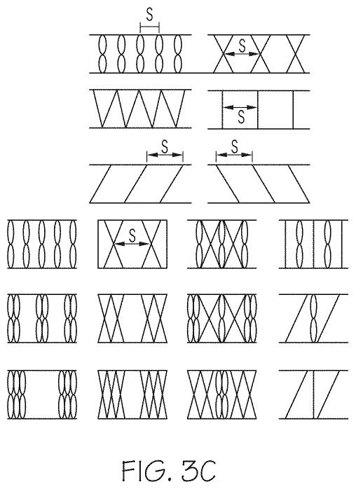

As shown in FIG. 2, the three-dimensional spacer structure 400 is a type of structure that has a first and second layer of fabric 460,470, wherein each layer of fabric is formed from reinforcement members that may be knitted, woven, nonwoven, interlaced or non-interlaced. The reinforcement members are preferably multifilament and formed of polyester, nylon, aramid, or hybrid cord of polyester, nylon or aramid. The first and second layers 460,470 of fabric are preferably oriented parallel with respect to each other and are interconnected with each other by a plurality of pile connecting members 480 that extend in a third or pile dimension. As shown in FIG. 3C, the pile connecting members 480 may form a straight connection of the first and second layers 460,470 that may extend in the radial direction, or be angled with the radial direction. The pile connecting members 480 may form an X shape, or letter 8 shape or combinations thereof. The pile connecting members are preferably monofilaments made of polyester material.

Preferably, the pile connecting members are grouped together in pile sections 485, wherein each pile section has a channel section 495 located on either side of the pile section 480. Each channel section 495 is a void that may remain a void or be filled with foam or other filler material. Thus the pile sections and channel sections alternate with each other across the axial width of the tire. Each channel and pile section extends continuously in the circumferential direction. The axial width of each channel section 495 and each pile section may range from 3 mm to 8 mm. For a given cross-section, it is preferred that there be at least 50 pile connecting members in each pile section 480.

The perpendicular distance between the connecting layers 460,470 or Z direction dimension of the three-dimensional structure is in the range of about 2 millimeters to about 25 millimeters, more preferably about 3-10 millimeters, and even more preferably in the range of 5-10 mm.

The three-dimensional fabric structure 400 is preferably oriented in the shear band so that the first and second layers 460,470 are aligned in parallel relation and extend across the axial direction as well as extending in the circumferential direction. The pile reinforcement members of three-dimensional fabric structure 400 are preferably aligned with the radial direction of the non-pneumatic tire.

Preferably, all of the channel sections 495 are filled with the filler material. The filler material may be an open or closed cell foam, polyurethane foam, EVA, a sealant or other soft material. The filler material may preferably comprise a compressive modulus between about 0.1 MPa to 200 MPa, more preferably 15 MPA to 80 MPA.

Preferably, the three-dimensional fabric structure 400 is treated with an RFL adhesive, which is a well-known resorcinol-formaldehyde resin/butadiene-styrene-vinyl pyridine terpolymer latex, or a blend thereof with a butadiene/styrene rubber latex, that is used in the tire industry for application to fabrics, fibers and textile cords for aiding in their adherence to rubber components (for example, see U.S. Pat. No. 4,356,219.) The reinforcement members may be single end dipped members (i.e., a single reinforcement member is dipped in RFL adhesive or adhesion promoter.)

The three-dimensional fabric structure 400 may have a density in the range of 700-1000 gram/meter2 as measured by DIN 12127. The compression stiffness of the three-dimensional fabric structure 400 may range from 50 to 600 kPa as measured by DIN/ISO 33861, and more preferably range from 100 to 250 kPa.

As shown in FIG. 2, the shear band may additionally include a first membrane layer 302. The first membrane layer 302 is preferably inextensible, and preferably located radially outward of the three-dimensional spacer structure 400. The shear band may further comprise a second membrane layer 304 that is arranged in parallel with the first membrane layer 302, and is the radially outermost membrane layer. The first and second membrane layers 302,304 each have reinforcement members or cords that are oriented at an angle in the range of 20 to 30 degrees relative to the tire equatorial plane. Preferably, the angle of the reinforcement cords of the first layer is in the opposite direction of the angle of the reinforcement cords in the second layer. It is additionally preferred that the reinforcement member or cords are inextensible.

Preferably, a layer of gum rubber 332,334 separates the three-dimensional spacer structure 330 from each reinforcement layer 302,310. There may optionally be additional layers of gum rubber 336,338 which separate the shear band and tread ring from the spoke structure 510.

As shown in FIG. 2, the shear band may additionally include a third membrane layer 310. The third membrane layer 310 is preferably inextensible, and preferably located radially inward of the three-dimensional spacer structure 400. The shear band may further comprise an optional fourth membrane layer 312 and is the radially innermost membrane layer. The third and fourth membrane layers 310,312 each have reinforcement members or cords that are oriented at an angle in the range of 0 to 5 degrees relative to the tire equatorial plane. The third and fourth membrane layers may be formed by spirally winding a continuous reinforcement cord. It is additionally preferred that the reinforcement member or cords are inextensible.

Located on each axially outer end of the three dimensional fabric structure is a first foam member 410 and a second foam member 420. The laterally outer foam members 410,420 provide support to the three dimensional fabric structure.

Any of the above described embodiments of the three-dimensional fabric structure may have a density in the range of 700-1000 gram/meter2 as measured by DIN 12127. The compression stiffness of any of the three-dimensional fabric structure may range from 50 to 600 kPa as measured by DIN/ISO 33861, and more preferably range from 100 to 250 kPa.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A nonpneumatic tire having an outer tread ring, wherein the outer tread ring further comprises a shear band, wherein the shear band includes a three-dimensional spacer structure, wherein the three-dimensional spacer structure is formed from a first and second layer of fabric, wherein each layer of material is connected to each other by a plurality of pile sections spaced apart from each other, wherein the three dimensional spacer structure further includes a plurality of channel sections located between the pile sections, wherein each pile section has a plurality of pile reinforcement members.

2. The nonpneumatic tire of claim 1 wherein the pile reinforcement members are comprised of monofilaments.

3. The nonpneumatic tire of claim 1 wherein the first and second layer of fabric are formed of reinforcement members comprised of polyfilaments.

4. The nonpneumatic tire of claim 1 wherein each channel section is filled with a filler material.

5. The nonpneumatic tire of claim 4 wherein the filler material may be an expandable foam.

6. The nonpneumatic tire of claim 4 wherein the filler material may be an open or closed cell foam.

7. The nonpneumatic tire of claim 1 wherein the filler material is EVA.

8. The nonpneumatic tire of claim 1 wherein the filler material is a sealant or other soft material.

9. The nonpneumatic tire of claim 1 wherein the filler material has a compressive modulus between about 0.1 MPA to 200 MPA, more preferably 15 MPA to 80 MPA.

10. The nonpneumatic tire of claim 1 further including a first and second membrane layer having reinforcement cords that are oriented at an angle in the range of 20 to 30 degrees relative to the tire equatorial plane.

11. The nonpneumatic tire of claim 10 wherein the first and second membrane layer are located radially outward of the three-dimensional spacer structure.

12. The nonpneumatic tire of claim 1 further including a third and fourth membrane layer having reinforcement cords that are oriented at an angle in the range of 0 to 5 degrees relative to the tire equatorial plane.

13. The nonpneumatic tire of claim 12 wherein the third and fourth membrane layer are located radially inward of the three dimensional spacer structure.

14. The nonpneumatic tire of claim 1 wherein the first and second layers are separated by a distance Z in the range of 2 to 15 millimeters, more preferably 3-8 mm, and even more preferably 5-10 mm.

15. The nonpneumatic tire of claim 1 wherein the pile connecting members are perpendicular to the first and second layer of material.

16. The nonpneumatic tire of claim 1 wherein the lateral ends of the three dimensional spacer structure have a foam member.

17. The nonpneumatic tire of claim 1 wherein the three-dimensional spacer structure has an axial width, and the connecting members do not extend the full axial width of the three-dimensional spacer structure.
